(19) United States
(12) Patent Application Publication
(10) Pub. No.: US 2026/0360606 A1
(43) Pub. Date: Nov. 12, 2026

(54) INTEGRATED PLANAR MAGNETICS FOR A BIDIRECTIONAL CLLLC RESONANT CONVERTER

(71) Applicant: Atieva, Inc., Newark, CA (US)

(72) Inventors: John Plamoottil Kurian, Fremont, CA (US); Sunil Kumar Dube, Fremont, CA (US); Nathaniel Sakon McCallum, San Mateo, CA (US); Sai Ram Abhishek Iruvanti, Union City, CA (US); Dung Anh Nguyen, Hayward, CA (US)

(21) Appl. No.: 19/199,952

(22) Filed: May 6, 2025

(51) Int. Cl. H01F 27/26; H01F 27/28; H02M 3/00

(52) U.S. Cl. CPC H01F 27/263; H01F 27/2804; H01F 27/2819; H02M 3/01

(57) ABSTRACT

A planar transformer comprises: a first planar core i) a first pillar, and ii) a second pillar; a second planar core, wherein a first gap is formed at the first pillar and a second gap is formed at the second pillar, the first gap and the second gap providing a magnetizing inductance; a primary winding trace around the first pillar and the second pillar; a first secondary winding trace around the first pillar and not around the second pillar; a second secondary winding trace formed around the first pillar and not around the second pillar; and an additional branch formed by the first planar core and the second planar core and including a third gap, wherein a leakage inductance for the planar transformer is provided by at least the additional branch.

### TECHNICAL FIELD

This document relates to integrated planar magnetics for a bidirectional CLLLC resonant converter.

### BACKGROUND

Some approaches have been used for providing direct current (DC) for one or more purposes. Some of these use capacitor-inductor-inductor-inductor-capacitor (CLLLC) DC-to-DC converters. These require a resonant inductance on the primary side as well as on the secondary side to be capable of bidirectional operation. Conventional implementations of a design that meets such requirements would require three different magnetic components: a resonant primary inductor, a main transformer with controlled magnetizing inductance and turns ratio, and a resonant secondary inductor. Existing discrete transformers with integrated leakage inductance use an extra core or a ferrite path between the windings to provide the leakage path. However, such implementations are associated with significant costs, weight, and size. For example, discrete magnetics having a large vertical profile (i.e., that extend significantly in the z-direction perpendicular to the plane of the circuit board) will increase the required size of the packaging for the converter. Also, existing discrete magnetic structures have suffered from significant losses associated with the points where leads from the magnetic structure terminate at (e.g., are bolted onto) the printed circuit board (PCB). Such losses reduce the efficiency of the converter and can also lead to unwanted temperature hot spots.

### SUMMARY

In a first aspect, a planar transformer comprises: a first planar core having a first main surface, the first planar core including i) a first pillar extending from the first main surface, and ii) a second pillar extending from the first main surface; a second planar core having a second main surface, the second main surface facing the first main surface, wherein a first gap is formed between an end of the first pillar and the second main surface, and wherein a second gap is formed between an end of the second pillar and the second main surface, wherein the first gap and the second gap provide a magnetizing inductance for the planar transformer; a primary winding trace formed around the first pillar and around the second pillar; a first secondary winding trace formed around the first pillar and not around the second pillar, the first secondary winding trace positioned between the first planar core and the primary winding trace; a second secondary winding trace formed around the first pillar and not around the second pillar, the second secondary winding trace positioned between the second planar core and the primary winding trace; and an additional branch formed by the first planar core and the second planar core and including a third gap, wherein a leakage inductance for the planar transformer is provided by at least the additional branch.

Implementations can include any or all of the following features. The additional branch comprises i) a first extension extending from the first planar core along the first main surface, and ii) a second extension extending from the second planar core along the second main surface, and iii) a member extending from one of the first extension or the second extension toward another of the first extension or the second extension, wherein the third gap is formed between an end of the member and the other of the first extension or the second extension. Each of the first planar core and the second planar core has substantially a rectangular shape not considering the first extension and the second extension. The first pillar and the second pillar are positioned on the first main surface so that a line from a center of the first pillar to a center of the second pillar is parallel to a long side of the rectangular shape. The third gap is aligned with the first main surface. The third gap is positioned between the first main surface and the second main surface. The third gap is aligned with the second main surface. The member comprises i) a piece of core material that forms the end of the member, and ii) a spacer positioned between the piece of core material and the one of the first extension or the second extension. The first extension and the second extension extend in a common direction that is perpendicular to a line from a center of the first pillar to a center of the second pillar. Each of the first extension and the second extension is aligned with one of the first pillar or the second pillar. The first extension extends along an entire length of a side of the first planar core, and wherein the second extension extends along an entire length of a side of the second planar core. The first planar core has substantially a rectangular shape not considering the first extension, wherein the second planar core has substantially a rectangular shape not considering the second extension, wherein the side of the first planar core is a long side of the rectangular shape of the first planar core, and wherein the side of the second planar core is a long side of the rectangular shape of the second planar core. The first extension and the second extension extend in a common direction along a line from a center of the first pillar to a center of the second pillar. The first planar core has substantially a rectangular shape not considering the first extension, wherein the second planar core has substantially a rectangular shape not considering the second extension, wherein the first extension extends along an entire length of a short side of the rectangular shape of the first planar core, and wherein the second extension extends along an entire length of a short side of the rectangular shape of the second planar core. The additional branch is a first additional branch, the planar transformer further comprising a second additional branch formed by the first planar core and the second planar core and including a fourth gap, wherein the leakage inductance for the planar transformer is provided by at least the first additional branch and the second additional branch. The first additional branch and the second additional branch are positioned on opposite sides of the first planar core and the second planar core from each other. Each of the first additional branch and the second additional branch is aligned with one of the first pillar or the second pillar. The first additional branch is aligned with one of the first pillar or the second pillar, and wherein the second additional branch is aligned with another of the first pillar or the second pillar. Each of the first pillar and the second pillar has substantially a cylinder shape. The first gap and the second gap are equal to each other, and wherein the third gap is greater than the first gap and the second gap. The planar transformer further comprises a gapping film positioned i) between the end of the first pillar and the second main surface, and ii) between the end of the second pillar and the second main surface, wherein the gapping film defines the first gap and the second gap. The planar transformer further comprises i) a first alignment pin that connects the first pillar to the second planar core, and ii) a second alignment pin that connects the second pillar to the second planar core. The planar transformer further comprises a thermal interface material positioned in the third gap.

### BRIEF DESCRIPTION OF DRAWINGS

FIG. 1 shows an example of circuitry that includes two planar transformers.

FIG. 2 shows an exploded view of some components of one of the planar transformer of FIG. 1.

FIG. 3 shows an example of a topology for a CLLLC DC-to-DC converter.

FIG. 4 shows an example of a planar transformer with the inductances of the CLLLC DC-to-DC converter of FIG. 3.

FIG. 5 shows an example of a reluctance diagram for the CLLLC DC-to-DC converter of FIG. 3.

FIG. 6 shows an example of a planar transformer with the reluctances of the reluctance diagram of FIG. 5.

FIG. 7 shows an example of a planar transformer with an additional branch formed by the planar cores.

FIG. 8 shows another example of a planar transformer with an additional branch formed by the planar cores.

FIG. 9 shows another example of a planar transformer with an additional branch formed by the planar cores.

FIG. 10 shows another example of a planar transformer with an additional branch formed by the planar cores.

FIG. 11 schematically shows examples of orientations of an additional branch relative to a planar core.

FIG. 12A shows a perspective view of an example of a planar transformer.

FIG. 12B shows a front view of the planar transformer of FIG. 12A.

FIG. 12C shows a side view of the planar transformer of FIG. 12A.

FIG. 13A shows a perspective view of an example of a planar transformer.

FIG. 13B shows a front view of the planar transformer of FIG. 13A.

FIG. 13C shows a side view of the planar transformer of FIG. 13A.

FIG. 14A shows a perspective view of an example of a planar transformer.

FIG. 14B shows a front view of the planar transformer of FIG. 14A.

FIG. 14C shows a side view of the planar transformer of FIG. 14A.

FIG. 15A shows a perspective view of an example of a planar transformer.

FIG. 15B shows a front view of the planar transformer of FIG. 15A.

FIG. 15C shows a side view of the planar transformer of FIG. 15A.

Like reference symbols in the various drawings indicate like elements.

### DETAILED DESCRIPTION

This document describes examples of systems and techniques that provide integrated planar magnetics for a bidirectional CLLLC resonant converter. A planar transformer can have an additional ferrite branch for providing the necessary leakage inductance required for the converter operation. Such a design can also improve efficiency by allowing overlapping of planar windings while getting the required leakage inductance with increased power density. A high turns ratio can be incorporated with low cost.

The present subject matter can reduce the magnetic component count and improve the efficiency of the CLLLC bidirectional converter. The profile of the planar transformer can be reduced, allowing better control of space on the PCB, less complicated routing on the PCB, and a reduction of the overall volume of the converter. The present subject matter can reduce the high current termination losses seen with some existing discrete magnetics. The present subject matter can reduce costs of production by reducing the weight of the system and/or lowering the manufacturing costs of individual components. The present subject matter can improve manufacturing operations by instead making the transformer become a part of the PCB assembly, thereby moving the process away from the unit assembly line, and/or by removing the need to perform a bolt-on connection of high-current busbars to the PCB. Also or instead, the present subject matter can improve the designing process for planar transformers in that one can first design the converter (i.e., decide how much inductance one needs) and thereafter determine what the gap in the additional ferrite branch should be; if that required inductance later changes, the size of the gap can be changed without otherwise redesigning the converter.

As such, advantages of the present subject matter can include, but are not limited to: providing a planar transformer with the magnetizing inductance as well as the primary and secondary resonant inductances integrated into a single magnetics structure; providing a planar transformer without external conductors that just includes the PCB winding; providing a leakage branch split across the primary and secondary winding to attain a symmetrical inductance network; improving efficiency by avoiding an additional planar magnetic component and interleaving of windings; saving space by integrating leakage into the transformer, thereby accomplishing a total volume reduction; reducing overall termination losses by reducing the component count; providing solutions particularly advantageous for converters having higher turns ratio which have a higher resonant (leakage) inductance requirement on the high turns side; and/or reducing the overall height by using planar magnetics.

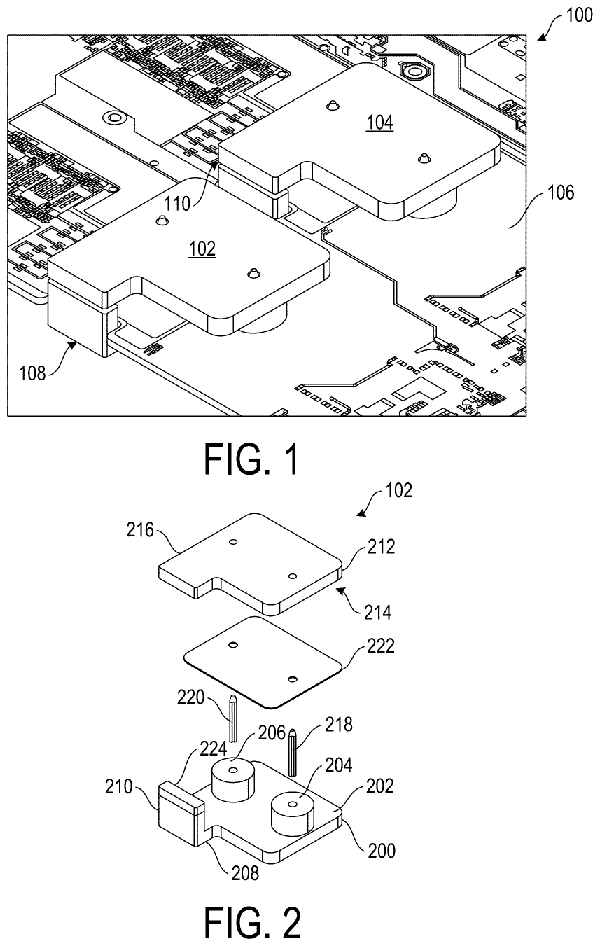

FIG. 1 shows an example of circuitry 100 that includes two planar transformers 102 and 104. The circuitry 100 or the planar transformer 102 or 104 can be used with one or more other examples described elsewhere herein. The planar transformers 102 and 104 are here installed side by side on a PCB 106 that provides conductive parts (e.g., winding traces) for the planar transformers 102 and 104. Each of the planar transformers 102 and 104 can be part of a respective bidirectional CLLLC resonant converter. As will be exemplified below, each of the planar transformers 102 and 104 defines gaps in magnetics structure that will provide a magnetizing inductance and a resonant inductance for the planar transformer. Here, the planar transformer 102 includes an additional branch 108 that has another gap, and the planar transformer 104 likewise includes an additional branch 110 that has another gap. The gaps of the additional branches 108 and 110 will provide respective leakage inductances for the planar transformers.

FIG. 2 shows an exploded view of some components of the planar transformer 102 of FIG. 1. For example, aspects of the planar transformer 102 that are provided on the PCB 106 (FIG. 1) are here omitted for clarity. The planar transformer 102 includes a planar core 200 that provides part of the magnetics structure for the transformer. For example, the planar core 200 includes ferrite of a grade that is suitable considering the required electrical and magnetic properties of the implementation. The planar core 200 has a main surface 202 at which pillars 204 and 206 are formed. The pillars 204 and 206 can be made of the same material (e.g., ferrite) as the planar core 200. The pillars 204 and 206 are parallel with each other and can extend in a direction perpendicular to the main surface 202. The pillars 204 and 206 can have any of various shapes, including, but not limited to, a cylinder shape.

The planar core 200 has an extension 208 that extends therefrom along the main surface 202. Here, a member 210 extends from the end of the extension 208 in a direction that is perpendicular to the main surface 202. The extension 208 and the member 210 can form part of the additional branch 108 (FIG. 1).

Not considering the extension 208, the planar core 200 here has substantially a rectangular shape (e.g., with one or more rounded corners). For example, the extension 208 extends from the main surface 202 at an intersection between one of the long sides and one of the short sides of the rectangular shape. The pillars 204 and 206 can be positioned on the main surface 202 so that a line from a center of the pillar 204 to a center of the pillar 206 is parallel to a long side of the rectangular shape. For example, the extension 208 can extend in a direction that is perpendicular to the line from the center of the pillar 204 to the center of the pillar 206.

The planar transformer 102 includes a planar core 212 that together with the planar core 200 provides the magnetics structure for the transformer. The planar core 212 can be made of the same material as the planar core 200. The planar core 200 has a main surface 214 that is here obscured from view. That is, the main surface 214 is parallel to, and faces, the main surface 202 when the planar transformer 102 has been assembled. The planar core 200 has an extension 216 that extends along the main surface 214. For example, the extension 216 can extend in a direction that is perpendicular to the line from the center of the pillar 204 to the center of the pillar 206. Here, each of the extensions 208 and 216 is aligned with the pillar 206. Not considering the extension 216, the planar core 212 can have substantially a rectangular shape. Together with the extension 208 and the member 210, the extension 216 can form the additional branch 108 (FIG. 1). Particularly, the gap of the additional branch 108 is here to be formed between the extension 216 and the end of the member 210.

The planar transformer 102 can use one or more alignment pins between the planar core 200 and the planar core 212. Here, an alignment pin 218 is configured to extend between a hole formed in the pillar 204 and a corresponding hole formed in the planar core 212 to connect the pillar 204 to the planar core 212. Similarly, an alignment pin 220 can be configured to extend between a hole formed in the pillar 206 and a corresponding hole formed in the planar core 212 to connect the pillar 206 to the planar core 212.

The planar transformer 102 forms a gap between an end of the pillar 204 and the main surface 214. Similarly, the planar transformer 102 forms a gap between an end of the pillar 206 and the main surface 214. The gaps can be equal to each other and provide a magnetizing inductance for the planar transformer 102. In some implementations, the gaps are created by positioning a gapping film 222 between the main surface 214 and the ends of the pillars 204 and 206 such that the resulting thickness of the gapping film 222 defines the common distance of the two gaps. That is, the dimension of the gaps can be defined by the gapping film 222. The gapping film 222 can have holes allowing the alignment pins 218 and 220 to pass through.

A thermal interface material 224 can be positioned in the gap formed between the extension 216 and the end of the member 210. The thermal interface material 224 can facilitate heat rejection from either of the planar cores 200 or 212 to the other. For example, when the circuitry 100 (FIG. 1) places either the planar core 200 or the planar core 212 in contact with a cooling element (e.g., a cold plate) for thermal control of the planar transformer 102, the thermal interface material 224 can allow heat transfer from the other of the planar cores 200 or 212.

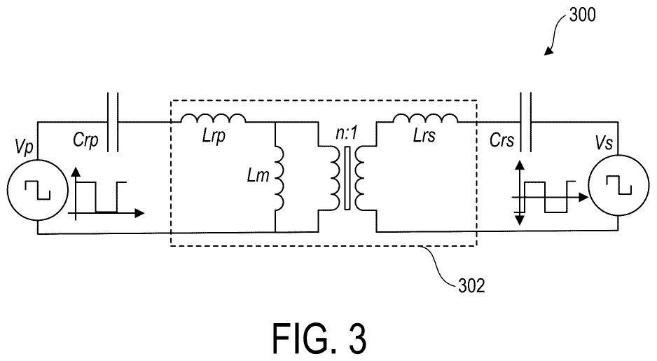

FIG. 3 shows an example of a topology for a CLLLC DC-to-DC converter 300. The CLLLC DC-to-DC converter 300 can be used with one or more other examples described elsewhere herein. The converter 300 has a primary side (e.g., a high-voltage side) with a primary voltage (Vp) and a primary side capacitor (Crp). The converter 300 has a secondary side (e.g., a low-voltage side) with a secondary voltage (Vs) and a secondary side capacitor (Crs). The converter 300 has a transformer 302 where inductances are integrated into a common magnetics structure. The transformer 302 has primary windings and secondary windings that are PBC traces and that are not interleaved with each other. Here, the turns ratio is exemplified as n:1, so there are n number of primary turns (n being any number) for each secondary turn. The transformer 302 has a resonant primary inductance (Lrp) at the primary side and a resonant secondary inductance (Lrs) at the secondary side. The resonant inductances on both the primary and the secondary sides facilitate bidirectional operation. The transformer 302 has a magnetizing inductance (Lm) at the primary side. In the present subject matter, the inductances Lrp, Lm and Lrs are integrated into a common structure.

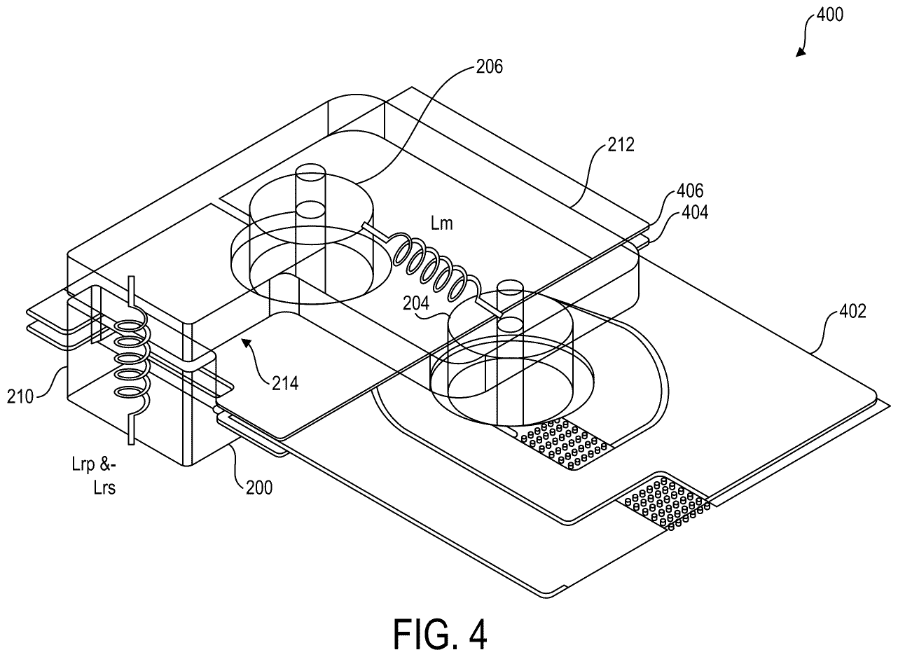

FIG. 4 shows an example of a planar transformer 400 with the inductances of the CLLLC DC-to-DC converter 300 of FIG. 3. The planar transformer 400 can be used with one or more other examples described elsewhere herein. The planar transformer 400 is shown partially transparent for clarity. The planar transformer 400 includes the planar cores 200 and 212 with windings between them. The windings can be implemented as winding traces on a PCB (e.g., the PCB 106 of FIG. 1). Here, only the windings and not the rest of the circuit board are shown for clarity. The windings include a primary winding trace 402 formed around the pillar 204 and around the pillar 206. The windings include a secondary winding trace 404 formed around the pillar 206 and not around the pillar 204. The secondary winding trace 404 is positioned between the planar core 200 and the primary winding trace 402. The windings include a secondary winding trace 406 formed around the pillar 206 and not around the pillar 204. The secondary winding trace 406 is positioned between the planar core 212 and the primary winding trace 402. That is, the primary winding trace 402 is positioned between the secondary winding traces 404 and 406.

In the planar transformer 400, the magnetizing inductance (Lm) is provided by the gaps between the planar core 212 and the respective ends of the pillars 204 and 206. The resonant primary and secondary inductances (Lrp and Lrs) are both provided by the gap between the end of the member 210 and the main surface 214 of the planar core 212.

As such, the above examples illustrate that a planar transformer (e.g., the planar transformer 102) can include: a first planar core (e.g., the planar core 200) having a first main surface (e.g., the main surface 202), the first planar core including i) a first pillar (e.g., the pillar 204) extending from the first main surface, and ii) a second pillar (e.g., the pillar 206) extending from the first main surface; a second planar core (e.g., the planar core 212) having a second main surface (e.g., the main surface 214), the second main surface facing the first main surface, wherein a first gap is formed between an end of the first pillar and the second main surface, and wherein a second gap is formed between an end of the second pillar and the second main surface, wherein the first gap and the second gap provide a magnetizing inductance for the planar transformer; a primary winding trace (e.g., the primary winding trace 402) formed around the first pillar and around the second pillar; a first secondary winding trace (e.g., the secondary winding trace 404) formed around the first pillar and not around the second pillar, the first secondary winding trace positioned between the first planar core and the primary winding trace; a second secondary winding trace (e.g., the secondary winding trace 406) formed around the first pillar and not around the second pillar, the second secondary winding trace positioned between the second planar core and the primary winding trace; and an additional branch (e.g., the extensions 208 and 216, and the member 210) formed by the first planar core and the second planar core and including a third gap, wherein a leakage inductance for the planar transformer is provided by at least the additional branch.

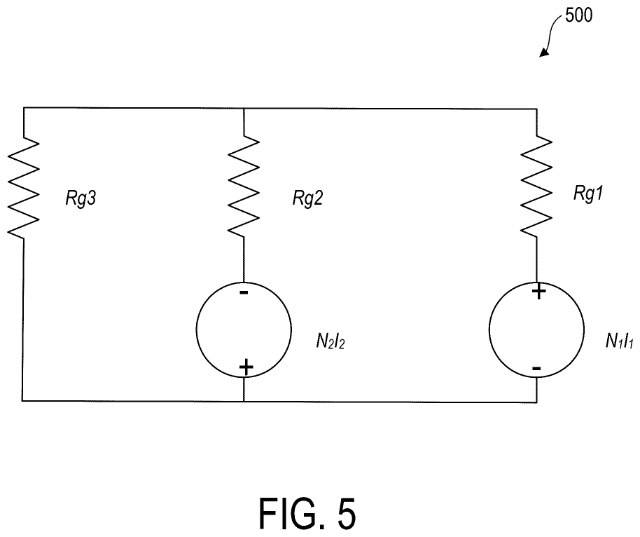

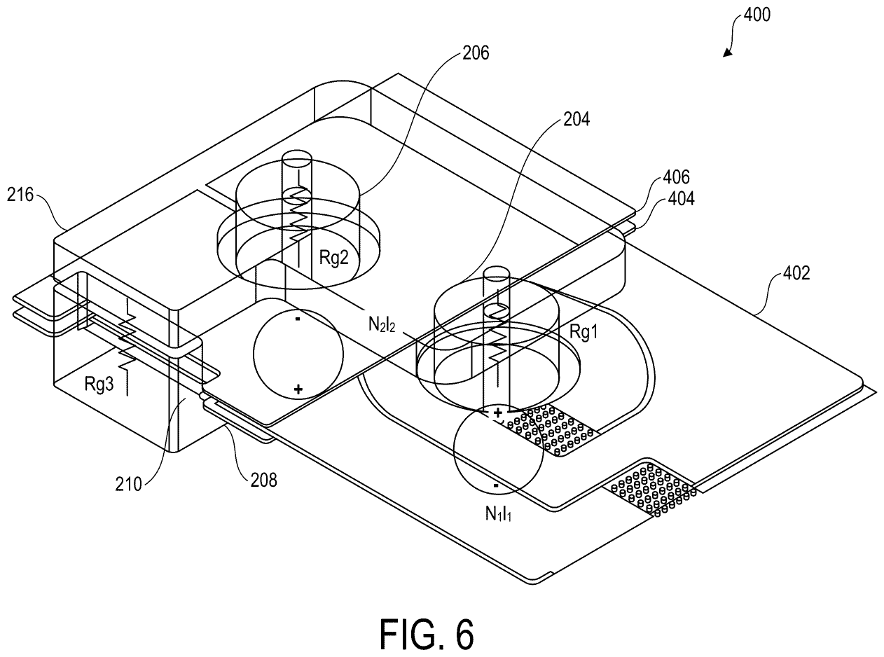

FIG. 5 shows an example of a reluctance diagram 500 for the CLLLC DC-to-DC converter 300 of FIG. 3. FIG. 6 shows an example of the planar transformer 400 with the reluctances of the reluctance diagram of FIG. 5. The reluctance diagram 500 indicates a reluctance Rg1 that is associated with a voltage source labeled N₁I₁. In the planar transformer 400 the reluctance Rg1 is shown at the gap of the pillar 204 which is surrounded by the primary winding trace 402. The reluctance diagram 500 indicates a reluctance Rg2 that is associated with a voltage source labeled N₂I₂. In the planar transformer 400 the reluctance Rg2 is shown at the gap of the pillar 206 which is surrounded by the primary winding trace 402, the secondary winding trace 404 and the secondary winding trace 406. The reluctance diagram 500 indicates a reluctance Rg3. In the planar transformer 400 the reluctance Rg3 is shown at the additional branch formed by the extensions 208 and 216, and the member 210.

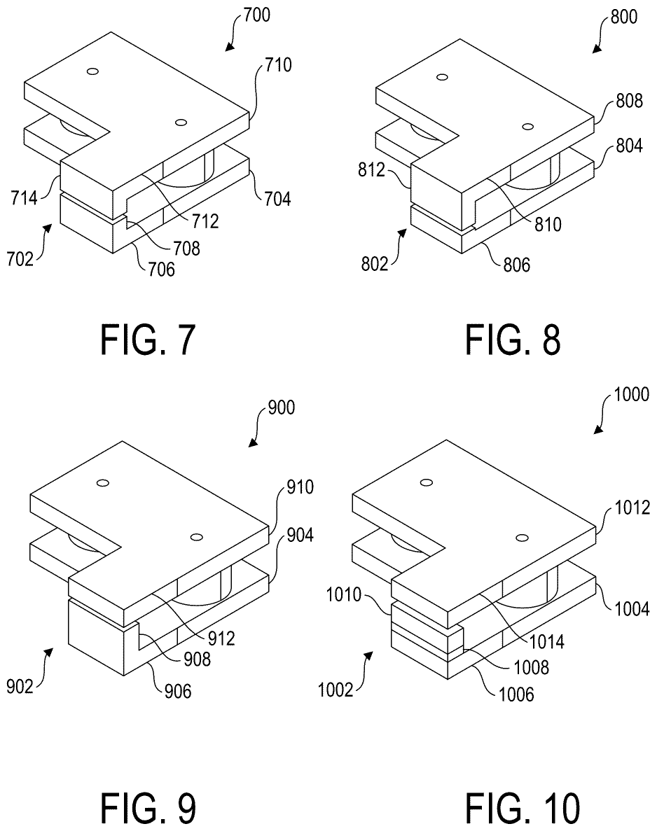

With reference to FIGS. 7-10, examples will be described relating to different ways of forming the gap of an additional branch. FIG. 7 shows an example of a planar transformer 700 with an additional branch 702 formed by the planar cores. The planar transformer 700 can be used with one or more other examples described elsewhere herein. The planar transformer 700 includes pillars similar to the pillars 204 and 206 (FIG. 2). The additional branch 702 is formed at a long side of the rectangular shape of the planar cores and is aligned with one of the pillars.

Here, a planar core 704 forms an extension 706 at the end of which a member 708 extends perpendicular to the extension 706. The planar transformer 700 includes a planar core 710 that forms an extension 712 at the end of which a member 714 extends perpendicular to the extension 712. That is, the members 708 and 714 here extend toward each other and perpendicular to the respective main surfaces of the planar cores 704 and 710 that are facing each other. A gap is formed between the ends of the members 708 and 714. The gap is positioned between (i.e., not aligned with either of) the main surfaces of the planar cores 704 and 710.

FIG. 8 shows another example of a planar transformer 800 with an additional branch 802 formed by the planar cores. The planar transformer 800 can be used with one or more other examples described elsewhere herein. The planar transformer 800 includes pillars similar to the pillars 204 and 206 (FIG. 2). The additional branch 802 is formed at a long side of the rectangular shape of the planar cores and is aligned with one of the pillars.

Here, a planar core 804 forms an extension 806. The planar transformer 800 includes a planar core 808 that forms an extension 810 at the end of which a member 812 extends perpendicular to the extension 810. That is, the member 812 here extends toward the extension 806 and perpendicular to the respective main surfaces of the planar cores 804 and 808 that are facing each other. A gap is formed between the extension 806 and the end of the member 812. The gap is aligned with the main surface of the planar core 804.

FIG. 9 shows another example of a planar transformer 900 with an additional branch 902 formed by the planar cores. The planar transformer 900 can be used with one or more other examples described elsewhere herein. The planar transformer 900 includes pillars similar to the pillars 204 and 206 (FIG. 2). The additional branch 902 is formed at a long side of the rectangular shape of the planar cores, and is aligned with one of the pillars.

Here, a planar core 904 forms an extension 906 at the end of which a member 908 extends perpendicular to the extension 906. The planar transformer 900 includes a planar core 910 that forms an extension 912. That is, the member 908 here extends toward the extension 912 and perpendicular to the respective main surfaces of the planar cores 904 and 910 that are facing each other. A gap is formed between the extension 912 and the end of the member 908. The gap is aligned with the main surface of the planar core 910.

FIG. 10 shows another example of a planar transformer 1000 with an additional branch 1002 formed by the planar cores. The planar transformer 1000 can be used with one or more other examples described elsewhere herein. The planar transformer 1000 includes pillars similar to the pillars 204 and 206 (FIG. 2). The additional branch 1002 is formed at a long side of the rectangular shape of the planar cores and is aligned with one of the pillars.

Here, a planar core 1004 forms an extension 1006. A spacer 1008 is positioned at the end of the extension 1006. The spacer 1008 holds a piece 1010 of core material so as to extend perpendicular to the extension 1006. The planar transformer 1000 includes a planar core 1012 that forms an extension 1014. That is, the piece 1010 of core material here extends toward the extension 1014 and perpendicular to the respective main surfaces of the planar cores 1004 and 1012 that are facing each other. A gap is formed between the extension 1014 and the end of the piece 1010 of core material. The gap is aligned with the main surface of the planar core 1012.

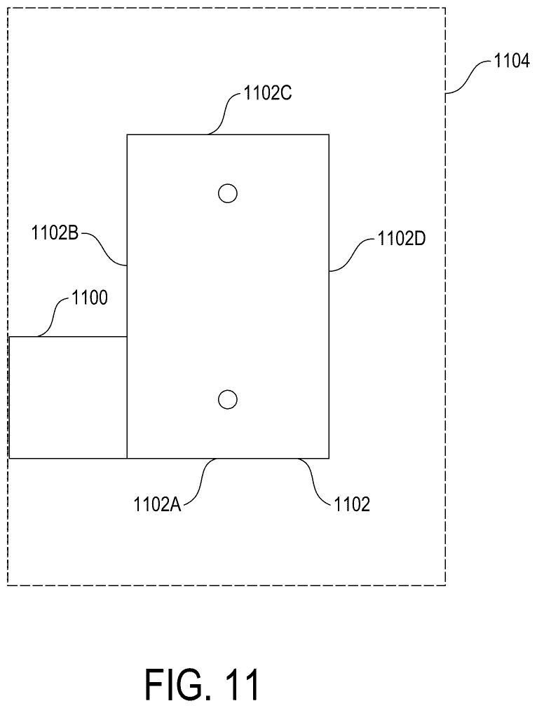

FIG. 11 schematically shows examples of orientations of an additional branch 1100 relative to a planar core 1102. Here, the planar core 1102 has substantially a rectangular shape with sides 1102A-1102D, respectively. The additional branch 1100 can be placed anywhere in a region 1104. The additional branch 1100 is currently shown positioned at the side 1102B, near the corner where the side 1102B meets the side 1102A. As another example, the additional branch 1100 can be placed anywhere else along the side 1102B than where shown in this example. As another example, the additional branch 1100 can be placed anywhere along the side 1102A. As another example, the additional branch 1100 can be placed anywhere along the side 1102C. As another example, the additional branch 1100 can be placed anywhere along the side 1102D.

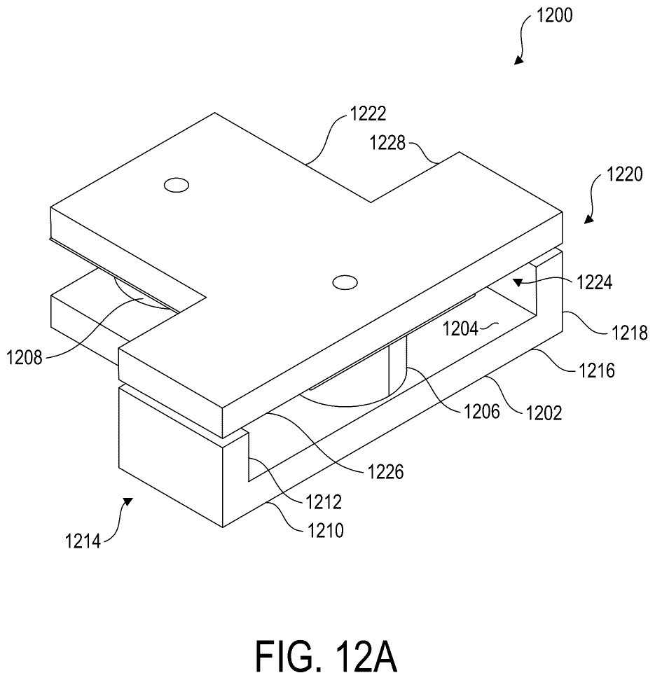

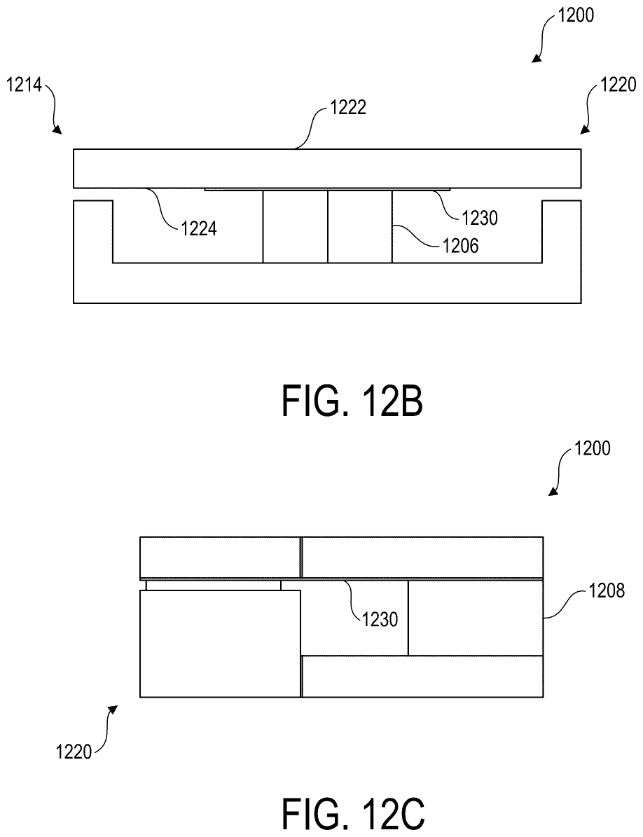

FIG. 12A shows a perspective view of an example of a planar transformer 1200. FIG. 12B shows a front view of the planar transformer 1200 of FIG. 12A. FIG. 12C shows a side view of the planar transformer of FIG. 12A. The planar transformer 1200 can be used with one or more other examples described elsewhere herein.

The planar transformer 1200 includes a planar core 1202 that provides magnetics structure for the transformer. For example, the planar core 1202 includes ferrite of a grade that is suitable considering the required electrical and magnetic properties of the implementation. The planar core 1202 has a main surface 1204 at which pillars 1206 and 1208 are formed. The pillars 1206 and 1208 can be made of the same material (e.g., ferrite) as the planar core 1202. The pillars 1206 and 1208 are parallel with each other and can extend in a direction perpendicular to the main surface 1204. The pillars 1206 and 1208 can have any of various shapes, including, but not limited to, a cylinder shape.

The planar core 1202 has an extension 1210 that extends therefrom along the main surface 1204. Here, a member 1212 extends from the end of the extension 1210 in a direction that is perpendicular to the main surface 1204. The extension 1210 and the member 1212 can form part of an additional branch 1214 of the planar transformer 1200. The planar core 1202 has an extension 1216 that extends therefrom along the main surface 1204. Here, a member 1218 extends from the end of the extension 1216 in a direction that is perpendicular to the main surface 1204. The extension 1216 and the member 1218 can form part of an additional branch 1220 of the planar transformer 1200.

Not considering the extensions 1210 and 1216, the planar core 1202 here has substantially a rectangular shape (e.g., with one or more rounded corners). For example, each of the extensions 1210 and 1216 extends from the main surface 1204 at an intersection between a respective one of the long sides and one of the short sides of the rectangular shape. The pillars 1206 and 1208 can be positioned on the main surface 1204 so that a line from a center of the pillar 1206 to a center of the pillar 1208 is parallel to a long side of the rectangular shape. For example, each of the extensions 1210 and 1216 can extend in a respective direction that is perpendicular to the line from the center of the pillar 1206 to the center of the pillar 1208.

The planar transformer 1200 includes a planar core 1222 that together with the planar core 1202 provides magnetics structure for the transformer. The planar core 1222 can be made of the same material as the planar core 1202. The planar core 1222 has a main surface 1224 (e.g., FIG. 12B). That is, the main surface 1224 is parallel to, and faces, the main surface 1204 (e.g., as shown). The planar core 1222 has an extension 1226 that extends along the main surface 1224. For example, the extension 1226 can extend in a direction that is perpendicular to the line from the center of the pillar 1206 to the center of the pillar 1208. Together with the extension 1210 and the member 1212, the extension 1226 can form the additional branch 1214. Particularly, a gap of the additional branch 1214 is here formed between the extension 1226 and the end of the member 1212.

The planar core 1222 has an extension 1228 that extends along the main surface 1224. For example, the extension 1228 can extend in a direction that is perpendicular to the line from the center of the pillar 1206 to the center of the pillar 1208, and opposite to that of the extension 1226. Here, each of the extensions 1226 and 1228 is aligned with the pillar 1206. Together with the extension 1216 and the member 1218, the extension 1228 can form the additional branch 1220. Particularly, a gap of the additional branch 1220 is here formed between the extension 1228 and the end of the member 1218.

Not considering the extensions 1226 and 1228, the planar core 1222 can have substantially a rectangular shape. A leakage inductance for the planar transformer 1200 can be provided by at least the additional branches 1214 and 1220. The additional branches 1214 and 1220 are here positioned on opposite sides of the planar cores 1202 and 1222 from each other. The additional branches 1214 and 1220 are here aligned with the pillar 1206.

The planar transformer 1200 forms a gap between an end of the pillar 1206 and the main surface 1224. Similarly, the planar transformer 1200 forms a gap between an end of the pillar 1208 and the main surface 1224. The gaps can be equal to each other and provide a magnetizing inductance for the planar transformer 1200. In some implementations, the gaps are created by positioning a gapping film 1230 between the main surface 1224 and the ends of the pillars 1206 and 1208 such that the resulting thickness of the gapping film 1230 defines the common distance of the two gaps. That is, the dimension of the gaps can be defined by the gapping film 1230. The gapping film 1230 can have holes allowing alignment pins to pass through.

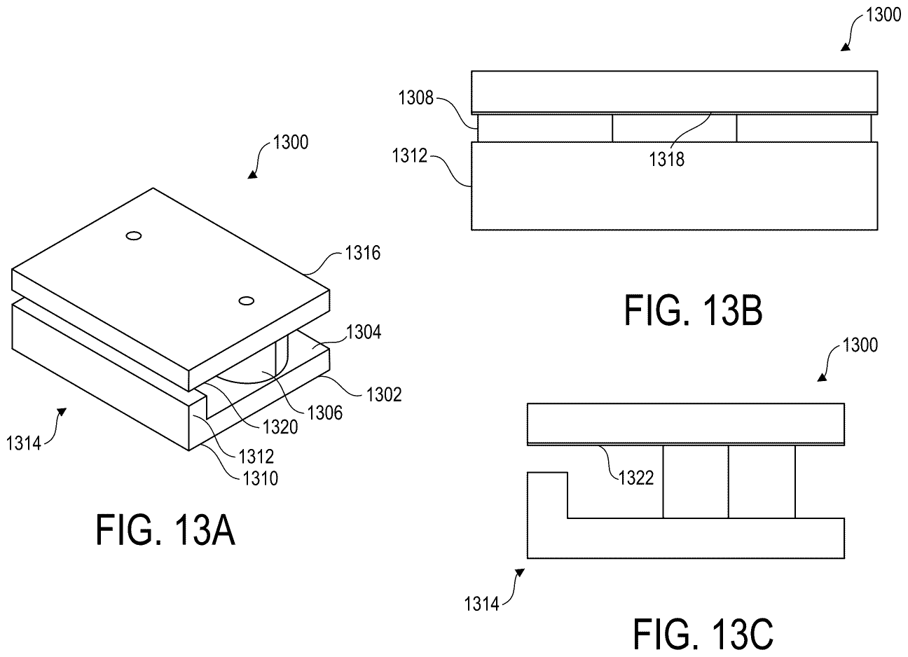

FIG. 13A shows a perspective view of an example of a planar transformer 1300. FIG. 13B shows a front view of the planar transformer 1300 of FIG. 13A. FIG. 13C shows a side view of the planar transformer 1300 of FIG. 13A. The planar transformer 1300 can be used with one or more other examples described elsewhere herein.

The planar transformer 1300 includes a planar core 1302 that provides magnetics structure for the transformer. For example, the planar core 1302 includes ferrite of a grade that is suitable considering the required electrical and magnetic properties of the implementation. The planar core 1302 has a main surface 1304 at which pillars 1306 and 1308 are formed. The pillars 1306 and 1308 can be made of the same material (e.g., ferrite) as the planar core 1302. The pillars 1306 and 1308 are parallel with each other and can extend in a direction perpendicular to the main surface 1304. The pillars 1306 and 1308 can have any of various shapes, including, but not limited to, a cylinder shape.

The planar core 1302 has an extension 1310 that extends therefrom along the main surface 1304. Here, a member 1312 extends from the end of the extension 1310 in a direction that is perpendicular to the main surface 1304. The extension 1310 and the member 1312 can form part of an additional branch 1314 of the planar transformer 1300.

Not considering the extension 1310, the planar core 1302 here has substantially a rectangular shape (e.g., with one or more rounded corners) smaller than when the extension 1310 is considered. For example, the extension 1310 extends from the main surface 1304 along an entire length of one of the long sides of the rectangular shape. The pillars 1306 and 1308 can be positioned on the main surface 1304 so that a line from a center of the pillar 1306 to a center of the pillar 1308 is parallel to a long side of the rectangular shape. For example, the extension 1310 can extend in a respective direction that is perpendicular to the line from the center of the pillar 1306 to the center of the pillar 1308.

The planar transformer 1300 includes a planar core 1316 that together with the planar core 1302 provides magnetics structure for the transformer. The planar core 1316 can be made of the same material as the planar core 1302. The planar core 1316 has a main surface 1318 (e.g., FIG. 13B). That is, the main surface 1318 is parallel to, and faces, the main surface 1304 (e.g., as shown). The planar core 1316 has an extension 1320 that extends along the main surface 1318. For example, the extension 1320 can extend in a direction that is perpendicular to the line from the center of the pillar 1306 to the center of the pillar 1308. Together with the extension 1310 and the member 1312, the extension 1320 can form the additional branch 1314. That is, the additional branch 1314 here extends along the entire length of one of the long sides of the rectangular shape. A gap of the additional branch 1314 is here formed between the extension 1320 and the end of the member 1312. A leakage inductance for the planar transformer 1300 can be provided by at least the additional branch 1314.

The planar transformer 1300 forms a gap between an end of the pillar 1306 and the main surface 1318. Similarly, the planar transformer 1300 forms a gap between an end of the pillar 1308 and the main surface 1318. The gaps can be equal to each other and provide a magnetizing inductance for the planar transformer 1300. In some implementations, the gaps are created by positioning a gapping film 1322 between the main surface 1318 and the ends of the pillars 1306 and 1308 such that the resulting thickness of the gapping film 1322 defines the common distance of the two gaps. That is, the dimension of the gaps can be defined by the gapping film 1322. The gapping film 1322 can have holes allowing alignment pins to pass through.

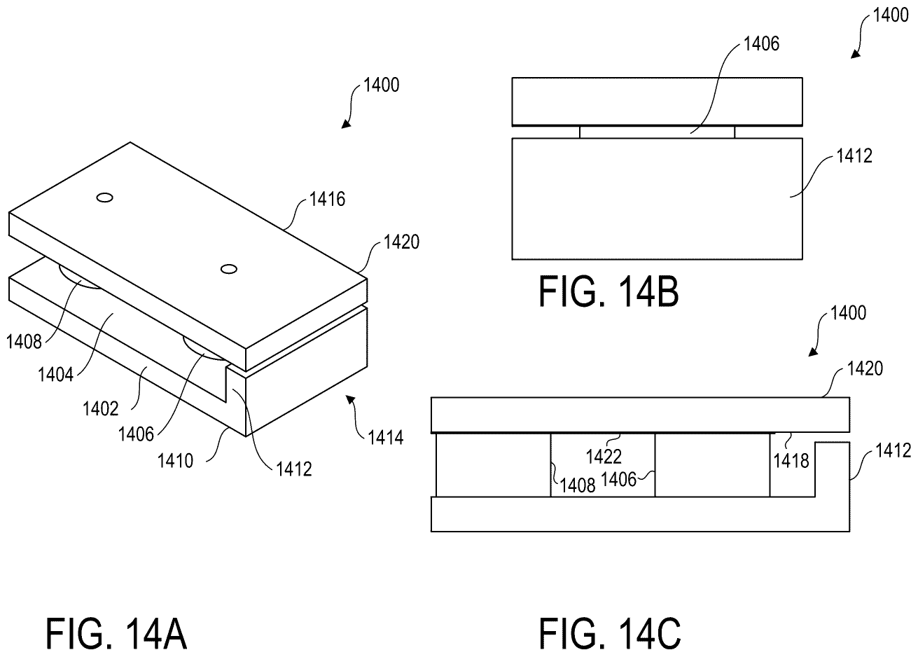

FIG. 14A shows a perspective view of an example of a planar transformer 1400. FIG. 14B shows a front view of the planar transformer 1400 of FIG. 14A. FIG. 14C shows a side view of the planar transformer 1400 of FIG. 14A. The planar transformer 1400 can be used with one or more other examples described elsewhere herein.

The planar transformer 1400 includes a planar core 1402 that provides magnetics structure for the transformer. For example, the planar core 1402 includes ferrite of a grade that is suitable considering the required electrical and magnetic properties of the implementation. The planar core 1402 has a main surface 1404 at which pillars 1406 and 1408 are formed. The pillars 1406 and 1408 can be made of the same material (e.g., ferrite) as the planar core 1402. The pillars 1406 and 1408 are parallel with each other and can extend in a direction perpendicular to the main surface 1404. The pillars 1406 and 1408 can have any of various shapes, including, but not limited to, a cylinder shape.

The planar core 1402 has an extension 1410 that extends therefrom along the main surface 1404. Here, a member 1412 extends from the end of the extension 1410 in a direction that is perpendicular to the main surface 1404. The extension 1410 and the member 1412 can form part of an additional branch 1414 of the planar transformer 1400.

Not considering the extension 1410, the planar core 1402 here has substantially a rectangular shape (e.g., with one or more rounded corners) smaller than when the extension 1410 is considered. For example, the extension 1410 extends from the main surface 1404 along an entire length of one of the short sides of the rectangular shape. The pillars 1406 and 1408 can be positioned on the main surface 1404 so that a line from a center of the pillar 1406 to a center of the pillar 1408 is parallel to a long side of the rectangular shape. For example, the extension 1410 can extend in a direction along the line from the center of the pillar 1406 to the center of the pillar 1408.

The planar transformer 1400 includes a planar core 1416 that together with the planar core 1402 provides magnetics structure for the transformer. The planar core 1416 can be made of the same material as the planar core 1402. The planar core 1416 has a main surface 1418 (e.g., FIG. 14C). That is, the main surface 1418 is parallel to, and faces, the main surface 1404 (e.g., as shown). The planar core 1416 has an extension 1420 that extends along the main surface 1418. For example, the extension 1420 can extend in a direction along the line from the center of the pillar 1406 to the center of the pillar 1408. That is, the extension 1420 and the extension 1410 can extend in a common direction along the line from the center of the pillar 1406 to the center of the pillar 1408. Together with the extension 1410 and the member 1412, the extension 1420 can form the additional branch 1414. That is, the additional branch 1414 here extends along the entire length of one of the short sides of the rectangular shape. A gap of the additional branch 1414 is here formed between the extension 1420 and the end of the member 1412. A leakage inductance for the planar transformer 1400 can be provided by at least the additional branch 1414.

The planar transformer 1400 forms a gap between an end of the pillar 1406 and the main surface 1418. Similarly, the planar transformer 1400 forms a gap between an end of the pillar 1408 and the main surface 1418. The gaps can be equal to each other and provide a magnetizing inductance for the planar transformer 1400. In some implementations, the gaps are created by positioning a gapping film 1422 between the main surface 1418 and the ends of the pillars 1406 and 1408 such that the resulting thickness of the gapping film 1422 defines the common distance of the two gaps. That is, the dimension of the gaps can be defined by the gapping film 1422. The gapping film 1422 can have holes allowing alignment pins to pass through.

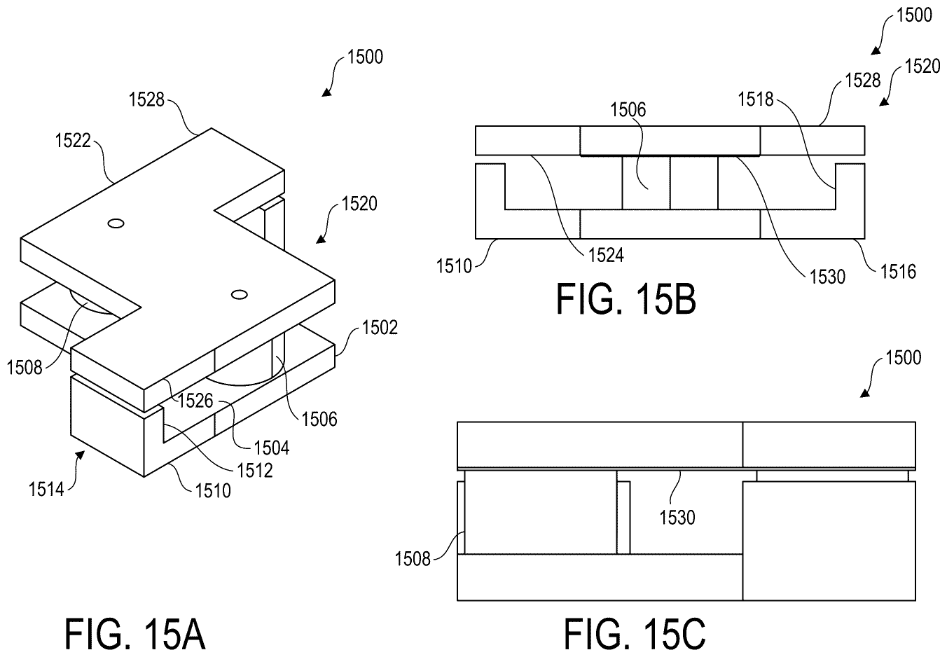

FIG. 15A shows a perspective view of an example of a planar transformer 1500. FIG. 15B shows a front view of the planar transformer 1500 of FIG. 15A. FIG. 15C shows a side view of the planar transformer 1500 of FIG. 15A. The planar transformer 1500 can be used with one or more other examples described elsewhere herein.

The planar transformer 1500 includes a planar core 1502 that provides magnetics structure for the transformer. For example, the planar core 1502 includes ferrite of a grade that is suitable considering the required electrical and magnetic properties of the implementation. The planar core 1502 has a main surface 1504 at which pillars 1506 and 1508 are formed. The pillars 1506 and 1508 can be made of the same material (e.g., ferrite) as the planar core 1502. The pillars 1506 and 1508 are parallel with each other and can extend in a direction perpendicular to the main surface 1504. The pillars 1506 and 1508 can have any of various shapes, including, but not limited to, a cylinder shape.

The planar core 1502 has an extension 1510 that extends therefrom along the main surface 1504. Here, a member 1512 extends from the end of the extension 1510 in a direction that is perpendicular to the main surface 1504. The extension 1510 and the member 1512 can form part of an additional branch 1514 of the planar transformer 1500. The planar core 1502 has an extension 1516 (e.g., FIG. 15B) that extends therefrom along the main surface 1504. Here, a member 1518 extends from the end of the extension 1516 in a direction that is perpendicular to the main surface 1504. The extension 1516 and the member 1518 can form part of an additional branch 1520 of the planar transformer 1200.

Not considering the extensions 1510 and 1516, the planar core 1502 here has substantially a rectangular shape (e.g., with one or more rounded corners). For example, each of the extensions 1510 and 1516 extends from the main surface 1504 at an intersection between a respective one of the long sides and a respective one of the short sides of the rectangular shape. The pillars 1506 and 1508 can be positioned on the main surface 1504 so that a line from a center of the pillar 1506 to a center of the pillar 1508 is parallel to a long side of the rectangular shape. For example, the extension 1510 can extend in a direction that is perpendicular to the line from the center of the pillar 1506 to the center of the pillar 1508. For example, the extension 1516 can extend in a direction that is perpendicular to the line from the center of the pillar 1506 to the center of the pillar 1508 and opposite to, and offset from along the line, the direction in which the extension 1510 extends.

The planar transformer 1500 includes a planar core 1522 that together with the planar core 1502 provides magnetics structure for the transformer. The planar core 1522 can be made of the same material as the planar core 1502. The planar core 1522 has a main surface 1524 (e.g., FIG. 15B). That is, the main surface 1524 is parallel to, and faces, the main surface 1504 (e.g., as shown). The planar core 1522 has an extension 1526 that extends along the main surface 1524. For example, the extension 1526 can extend in a direction that is perpendicular to the line from the center of the pillar 1506 to the center of the pillar 1508. Together with the extension 1510 and the member 1512, the extension 1526 can form the additional branch 1514. Particularly, a gap of the additional branch 1514 is here formed between the extension 1526 and the end of the member 1512.

The planar core 1522 has an extension 1528 that extends along the main surface 1524. For example, the extension 1528 can extend in a direction that is perpendicular to the line from the center of the pillar 1506 to the center of the pillar 1508 and opposite to, and offset from along the line, the direction in which the extension 1526 extends. Here, each of the extensions 1516 and 1528 is aligned with the pillar 1508. Together with the extension 1516 and the member 1518, the extension 1528 can form the additional branch 1520. Particularly, a gap of the additional branch 1520 is here formed between the extension 1528 and the end of the member 1518.

Not considering the extensions 1526 and 1528, the planar core 1522 can have substantially a rectangular shape. A leakage inductance for the planar transformer 1500 can be provided by at least the additional branches 1514 and 1520. The additional branches 1514 and 1520 are here positioned on opposite sides of the planar cores 1502 and 1522 from each other, and offset from each other along the line from the center of the pillar 1506 to the center of the pillar 1508. The additional branch 1514 is here aligned with the pillar 1506. The additional branch 1520 is here aligned with the pillar 1508.

The planar transformer 1500 forms a gap between an end of the pillar 1506 and the main surface 1524. Similarly, the planar transformer 1500 forms a gap between an end of the pillar 1508 and the main surface 1524. The gaps can be equal to each other and provide a magnetizing inductance for the planar transformer 1500. In some implementations, the gaps are created by positioning a gapping film 1530 between the main surface 1524 and the ends of the pillars 1506 and 1508 such that the resulting thickness of the gapping film 1530 defines the common distance of the two gaps. That is, the dimension of the gaps can be defined by the gapping film 1530. The gapping film 1530 can have holes allowing alignment pins to pass through.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A planar transformer comprising:
a first planar core having a first main surface, the first planar core including i) a first pillar extending from the first main surface, and ii) a second pillar extending from the first main surface;
a second planar core having a second main surface, the second main surface facing the first main surface, wherein a first gap is formed between an end of the first pillar and the second main surface, and wherein a second gap is formed between an end of the second pillar and the second main surface, wherein the first gap and the second gap provide a magnetizing inductance for the planar transformer;
a primary winding trace formed around the first pillar and around the second pillar;
a first secondary winding trace formed around the first pillar and not around the second pillar, the first secondary winding trace positioned between the first planar core and the primary winding trace;
a second secondary winding trace formed around the first pillar and not around the second pillar, the second secondary winding trace positioned between the second planar core and the primary winding trace; and
an additional branch formed by the first planar core and the second planar core and including a third gap, wherein a leakage inductance for the planar transformer is provided by at least the additional branch.

2. The planar transformer of claim 1, wherein the additional branch comprises i) a first extension extending from the first planar core along the first main surface, and ii) a second extension extending from the second planar core along the second main surface, and iii) a member extending from one of the first extension or the second extension toward another of the first extension or the second extension, wherein the third gap is formed between an end of the member and the other of the first extension or the second extension.

3. The planar transformer of claim 2, wherein each of the first planar core and the second planar core has substantially a rectangular shape not considering the first extension and the second extension.

4. The planar transformer of claim 3, wherein the first pillar and the second pillar are positioned on the first main surface so that a line from a center of the first pillar to a center of the second pillar is parallel to a long side of the rectangular shape.

5. The planar transformer of claim 2, wherein the third gap is aligned with the first main surface.

6. The planar transformer of claim 2, wherein the third gap is positioned between the first main surface and the second main surface.

7. The planar transformer of claim 2, wherein the third gap is aligned with the second main surface.

8. The planar transformer of claim 2, wherein the member comprises i) a piece of core material that forms the end of the member, and ii) a spacer positioned between the piece of core material and the one of the first extension or the second extension.

9. The planar transformer of claim 2, wherein the first extension and the second extension extend in a common direction that is perpendicular to a line from a center of the first pillar to a center of the second pillar.

10. (canceled)

11. The planar transformer of claim 9, wherein the first extension extends along an entire length of a side of the first planar core, and wherein the second extension extends along an entire length of a side of the second planar core.

12. The planar transformer of claim 11, wherein the first planar core has substantially a rectangular shape not considering the first extension, wherein the second planar core has substantially a rectangular shape not considering the second extension, wherein the side of the first planar core is a long side of the rectangular shape of the first planar core, and wherein the side of the second planar core is a long side of the rectangular shape of the second planar core.

13. The planar transformer of claim 2, wherein the first extension and the second extension extend in a common direction along a line from a center of the first pillar to a center of the second pillar.

14. The planar transformer of claim 13, wherein the first planar core has substantially a rectangular shape not considering the first extension, wherein the second planar core has substantially a rectangular shape not considering the second extension, wherein the first extension extends along an entire length of a short side of the rectangular shape of the first planar core, and wherein the second extension extends along an entire length of a short side of the rectangular shape of the second planar core.

15. The planar transformer of claim 1, wherein the additional branch is a first additional branch, the planar transformer further comprising a second additional branch formed by the first planar core and the second planar core and including a fourth gap, wherein the leakage inductance for the planar transformer is provided by at least the first additional branch and the second additional branch.

16. The planar transformer of claim 15, wherein the first additional branch and the second additional branch are positioned on opposite sides of the first planar core and the second planar core from each other.

17. The planar transformer of claim 16, wherein each of the first additional branch and the second additional branch is aligned with one of the first pillar or the second pillar.

18. The planar transformer of claim 17, wherein the first additional branch is aligned with one of the first pillar or the second pillar, and wherein the second additional branch is aligned with another of the first pillar or the second pillar.

19. (canceled)

20. (canceled)

21. The planar transformer of claim 1, further comprising a gapping film positioned i) between the end of the first pillar and the second main surface, and ii) between the end of the second pillar and the second main surface, wherein the gapping film defines the first gap and the second gap.

22. The planar transformer of claim 1, further comprising i) a first alignment pin that connects the first pillar to the second planar core, and ii) a second alignment pin that connects the second pillar to the second planar core.

23. The planar transformer of claim 1, further comprising a thermal interface material positioned in the third gap.
